(19) United States
(12) Patent Application Publication
(10) Pub. No.: US 2026/0229951 A1
(43) Pub. Date: Aug. 6, 2026

(54) ELECTRIC MACHINE

(71) Applicant: HUTCHINSON, PARIS (FR)

(72) Inventor: Jean-Yves MOUNIER, PAUCOURT (FR)

(73) Assignee: HUTCHINSON, PARIS (FR)

(21) Appl. No.: 19/150,992

(22) PCT Filed: Jan. 25, 2024
(86) PCT No.: PCT/FR2024/050103

§ 371 Date: Jul. 25, 2025

(30) Foreign Application Priority Data
Jan. 25, 2023 (FR) 2300698

(51) Int. Cl. H02K 5/20; H02K 9/19

(52) U.S. Cl. CPC H02K 5/203; H02K 9/19

(57) ABSTRACT

An electric machine including a stator and a rotor which is capable of pivoting about an axis, an annular cooling element extending around at least a portion of the stator, the cooling element including at least one circulation channel capable of allowing the circulation of a coolant, and an annular casing extending around the axis and at least partly surrounding the cooling element. The stator has a first coefficient of thermal expansion, the cooling element having a second coefficient of thermal expansion which is greater than the first coefficient of thermal expansion, the cooling element being mounted in a prestressed manner around the stator, the casing having a third coefficient of thermal expansion which is greater than or equal to the first coefficient of thermal expansion and is less than the second thermal coefficient.

### FIELD

The invention lies within the technical field of electric machines suitable for forming an electric motor or generator.

### BACKGROUND

The current strong growth of electric vehicles requires designing electric motors that combine compactness and high power. The recent use of electric motors for the propulsion of the new generation of land and air vehicles requires the development of a series of more efficient and high-performance electric motors. An increase in the power density of electric motors can be limited by electrical and thermal constraints. The increase in temperature in electric machines results from electromagnetic and mechanical losses, generating heat in the motor components.

An electric motor typically consists of a stator, a rotor, and a casing. The stator is generally made of laminations and a winding, i.e. a coil of conductive wires, of which the majority is embedded in slots in the stator. The operation of an electric motor consists of circulating an electric current through the winding, which results in a magnetic field. This creates a magnetic moment and drives the rotation of the rotor.

The conversion of this electrical energy into mechanical energy by the motor is not without load losses. For electric motors, between 5 and 15% of the incoming electrical power is lost, depending on the type of motor.

These losses can be classified into several categories: mechanical losses, iron losses, losses related to parasitic loads, and Joule losses.

Mechanical losses are mainly due to friction within the bearings and to the aerodynamic heating resulting from a very high velocity gradient in the air gap between the rotor and the stator.

Iron losses and Joule losses are vectors of thermal losses, the former in the stator laminations and the latter in the coil winding. Iron losses are produced by magnetic effects (hysteresis and eddy current), and Joule losses in the windings are due to the resistivity of the copper in the conductors.

It is therefore essential to ensure an effective thermal management of the electric motor in order to obtain a motor with a high power density. Effective cooling allows combining a compact and high-power motor, reducing the overall dimensions of the car's component elements. Furthermore, a lower operating temperature prevents degradation of the thermal and electrical insulation surrounding each constituent conductor of the winding. The insulation's lifespan decreases with increasing temperature.

For a permanent magnet motor, which is currently one of the most widely used electric motors, the magnetic properties of the permanent magnets are highly dependent on the operating temperature. A sharp rise in temperature can lead to irreversible demagnetization. Finally, an increase in the motor temperature leads to an increase in Joule losses. One will note that the electrical resistance of the conductors increases linearly with an increase in motor temperature.

To reduce the temperature, it is known to use a heat transfer fluid to carry away the heat generated by the motor. Conventional cooling thus involves passing a flow of water or air over the casing surrounding the stator. However, such cooling has limited performance because the heat generated by the coils must pass through areas and interfaces where thermal conduction is low.

It is also known to insert a jacket between the stator and the casing of the electric motor, said jacket defining channels allowing a coolant to circulate.

Document WO 2021/236565 discloses an electric machine comprising a stator, a rotor which is capable of pivoting about an axis, and a cooling element extending around at least a portion of the stator, between the stator and the casing. The cooling element is in the form of an annular jacket comprising circulation channels allowing the circulation of a coolant, said jacket being in contact with both the casing, radially externally, and the stator, radially internally.

The invention aims to propose an electric machine capable of adapting to different operating phases of said machine.

### SUMMARY

To meet such a need, the invention proposes an electric machine comprising
a stator and a rotor which is capable of pivoting about an axis,
an annular cooling element extending around at least a portion of the stator, said cooling element comprising at least one circulation channel capable of allowing the circulation of a coolant,
an annular casing extending around said axis and at least partly surrounding the cooling element,
characterized in that the stator has a first coefficient of thermal expansion, the cooling element having a second coefficient of thermal expansion which is greater than the first coefficient of thermal expansion, said cooling element being mounted around the stator in a prestressed manner,
the casing having a third coefficient of thermal expansion which is greater than or equal to the first coefficient of thermal expansion and is less than the second thermal coefficient, said casing surrounding the cooling element at least in part, a radial annular clearance being formed between the cooling element and the casing, at a first temperature, said clearance being capable of being filled in by the differential expansion between the cooling element and the casing, at a second temperature.

The terms axial, radial, and circumferential are defined relative to the rotor's axis of rotation.

Prestressed mounting, or tight mounting, means that the diameter of the cooling element at rest, i.e. when not mounted around the stator, is smaller than the diameter of the cooling element in its mounted state around the stator.

Thus, during operation, when the temperature of the cooling element and the stator increases, the cooling element expands faster than the stator. In other words, the radially outer diameter of the cooling element increases faster than the outer diameter of the stator. In this manner, the prestressing of the cooling element is partially reduced. This prestress is, however, determined so that, at a normal operating temperature, for example between 90° C. and 120° C., the prestress is not zero. In other words, regardless of the operating temperature, contact between the cooling element and the stator is maintained.

Such contact makes it possible to ensure, for example, a seal between the cooling element and the stator and/or heat dissipation, by the contact between said cooling element and the stator.

Furthermore, contact between the cooling element and the casing beyond the second temperature allows the casing to be used as a heat sink.

Such contact also provides better vibration attenuation during operation, particularly when the cooling element is made of an elastomer material.

Thus, in a first operating state, the temperature of the fluid circulating in the channel of the cooling element is at a low temperature, for example the first temperature.

In such case, it is generally necessary to increase the temperature of this fluid to ensure optimal operation of the electric machine. Indeed, if the temperature is too low, this fluid may have excessive viscosity, which can lead to excessive consumption of fluid and/or of the energy required for its circulation. In the present document, this is achieved by reducing the heat exchange surfaces, i.e. by avoiding contact between the cooling element and the casing, due to the radial clearance between them.

Conversely, once the optimal temperature (for example, the second temperature) is reached, it is generally necessary to maximize the dissipation of heat. In the present document, such dissipation is achieved by contact between said cooling element and the casing.

Differential expansion phenomena are therefore used to form a thermal switch that is beneficial to the operation of the assembly.

The stator and the cooling element may each extend around the X axis.

The stator may comprise an annular body and a winding. The body may be made of metal. In particular, the body may be formed of a stack of metal sheets. The body may be made of steel.

The first coefficient of thermal expansion may be between 10×10⁻⁶ K⁻¹ and 12×10⁻⁶ K⁻¹.

The second coefficient of thermal expansion may be between 40×10⁻⁶ K⁻¹ and 140×10⁻⁶ K⁻¹.

The third coefficient of thermal expansion may be between 20×10⁻⁶ K⁻¹ and 30×10⁻⁶ K⁻¹.

The casing may be made of metal. The casing may be made of aluminum.

The radial clearance between the cooling element and the casing may be between 1 and 10 mm.

The second temperature may be between 70 and 110° C.

The matrix of the cooling element may be made, at least in part, of an elastomer material, for example rubber.

The elastomer material may be formulated to exhibit a thermal conductivity λ>1 W·m−1·K−1.

Said elastomer material is, for example, capable of withstanding oils and/or high temperatures, for example on the order of 150° C., over long periods of time or continuously.

Said cooling element is, for example, made of an elastomer selected from the following list: polyacrylics (ACM), ethylene acrylate copolymers (AEM), fluorocarbon polymers (FKM), fluorosilicones (FVMQ), hydrogenated nitrile (HNBR), or is composed of a blend of several elastomers from this list.

Said elastomer may comprise fillers, for example such as carbon fillers (e.g. graphite, carbon nanotubes, carbon black, or graphene), metal fillers (e.g. Ag, Cu, Al, TiO2, AlN), and/or ceramic fillers (BN, Si).

Such fillers facilitate heat exchange and the radially outward evacuation of heat.

The mass filler content is, for example, between 30 and 50%.

The cooling element may comprise elongate reinforcement elements embedded in and integral with a matrix of synthetic material of the cooling element, the reinforcement elements being regularly distributed around the circumference, at least a portion of the reinforcement elements each extending along a spiral path around the jacket, the projection of the spiral path of each reinforcement element onto a plane parallel to the axis forming an angle with said axis, the angle being between 46 and 54°.

The presence and orientation of the reinforcement elements makes it possible to limit the axial expansion of the cooling element. One will note that, during such expansion, the reinforcement elements will tend to reorient themselves to a so-called neutral angle having a value of 54.75°.

The radially outer surface of the cooling element may comprise at least one textured area comprising recessed portions and/or protruding portions, intended to bear against the casing.

Said recessed portions and/or said protruding portions are suitable for gradually bearing against the casing as the cooling element expands under the effect of the temperature increase. In other words, the contact area between said cooling element and the casing may gradually increase with the temperature.

The reinforcement elements may be wires or threads.

The wires or threads may be textile threads, at least in part, for example of polyamide or polyester. The wires or threads may be metal wires, at least in part, for example of stainless steel or copper.

The diameter of each wire or thread may be between 0.25 and 2 mm, for example around 0.5 mm.

The coolant may be a heat transfer fluid or a refrigerant.

Said channel may lead, at least in part, to the radially inner surface of the cooling element, said channel being partly delimited by said cooling element and partly by the outer surface of the stator.

In such case, the prestressing of the cooling element on the stator also ensures the fluidtightness of said channel.

At least one axial end of the cooling element may be axially recessed relative to the corresponding end of the stator, at the first temperature.

The term “recessed” means that said end of the cooling element does not protrude axially beyond the stator.

Said end of the cooling element may be axially located at or beyond said corresponding end of the stator, at a second temperature that is higher than the first temperature.

The axial distance between said end of the cooling element and said corresponding end of the stator may be limited at the second temperature, for example may be less than 1 mm. This ensures that the axial expansion of the cooling element beyond the stator remains controlled, for example so as to avoid any unwanted interaction with nearby elements.

The opposite axial end of the cooling element may be capable of coming to bear against a flange axially integral with the stator and/or with the casing, so as to prevent the movement of said opposite axial end beyond the corresponding end of the stator. Such a feature allows limiting the axial expansion of the cooling element in a single direction.

The coolant may be oil or a non-electrically conductive fluid.

The cooling element may comprise several channels arranged in parallel, extending circumferentially.

Each channel may comprise a first end forming a coolant inlet and a second end forming a coolant outlet.

The first ends of the channels may be connected together to form a common inlet. The second ends of the channels may be connected together to form a common outlet.

The inlet of each channel may be located in the upper portion of the cooling element. The outlet of each channel may be located in the lower portion of the cooling element.

The cooling element may comprise at least two opposite channels, each extending from an upper portion to a lower portion of the cooling element.

The inlets of said two opposite channels may form a common inlet. The outlets of said two channels may be axially opposite one another and be at two opposite axial ends of the cooling element.

The stator may comprise an annular body having an axis X, and a winding extending axially beyond the body at an axial end zone of the winding, the channel comprising an outlet at an axial end of the element, next to a corresponding axial end of the body and next to the corresponding axial end zone of the winding.

The outlet of the channel may be located in the lower portion of the cooling element.

The cooling element may also comprise an auxiliary channel that leads axially to the top of the cooling element, next to a corresponding axial end of the body and next to the corresponding axial end zone of the winding.

The winding may extend axially on each side of the body. In such a case, the element may comprise two auxiliary channels which each lead axially to one of the end zones of the winding.

The electric machine may comprise a supply tank capable of supplying each channel with coolant and a collection tank capable of collecting the coolant coming from each channel. A heat exchanger may be combined with the collection tank in order to maintain a constant coolant temperature.

The supply tank may be located next to the upper portion of the stator. The collection tank may be located next to the lower portion of the stator.

The electric machine may comprise a pump for conveying coolant from the collection tank to the supply tank.

The present document also proposes a method of operating an electric machine of the aforementioned type, wherein, at the first temperature, a radial annular clearance is formed between the cooling element and the casing, and wherein, at the second temperature, said clearance is filled in by the differential expansion between the cooling element and the casing.

### BRIEF DESCRIPTION OF FIGURES

Other features and advantages of this disclosure will become apparent from the following detailed description, with reference to the accompanying drawings, in which:

FIG. 1 is an exploded perspective view of an electric machine according to one embodiment of the invention,

FIG. 2 is a perspective view of a portion of the electric machine, the cooling element being represented in “negative” form so as to show only the channels of the cooling element,

FIG. 3 is a perspective view of a portion of the electric machine,

FIG. 4 is a perspective view of the cooling element, with the reinforcement elements schematically represented by dotted lines,

FIG. 5 is a view of a portion of the cooling element expanded or projected onto a plane parallel to the axis of said cooling element, the reinforcement elements being shown in dotted lines,

FIG. 6 is a section view in a radial plane, illustrating the cross-sections of the stator, cooling element, and casing, at the first operating temperature,

FIG. 7 is a view corresponding to FIG. 6, at the second operating temperature,

FIG. 8 illustrates various embodiments of the protruding and/or recessed areas of the radially outer surface of the cooling element.

### DETAILED DESCRIPTION

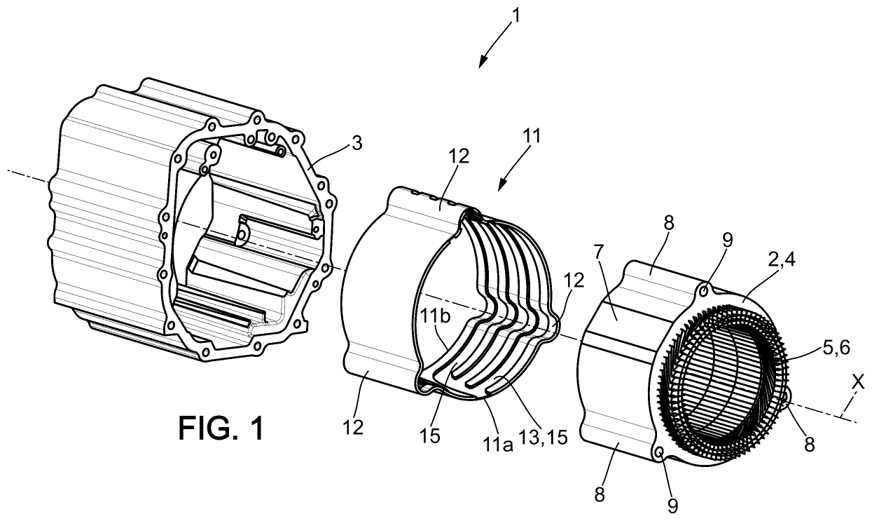

FIGS. 1 to 7 illustrate an electric machine 1 according to a first embodiment of the invention.

This comprises a stator 2 which may comprise an annular body 4 having an axis X and a winding 5 which may extend axially beyond the body 4, on each side of the body 4, at axial end zones 6 of the winding 5.

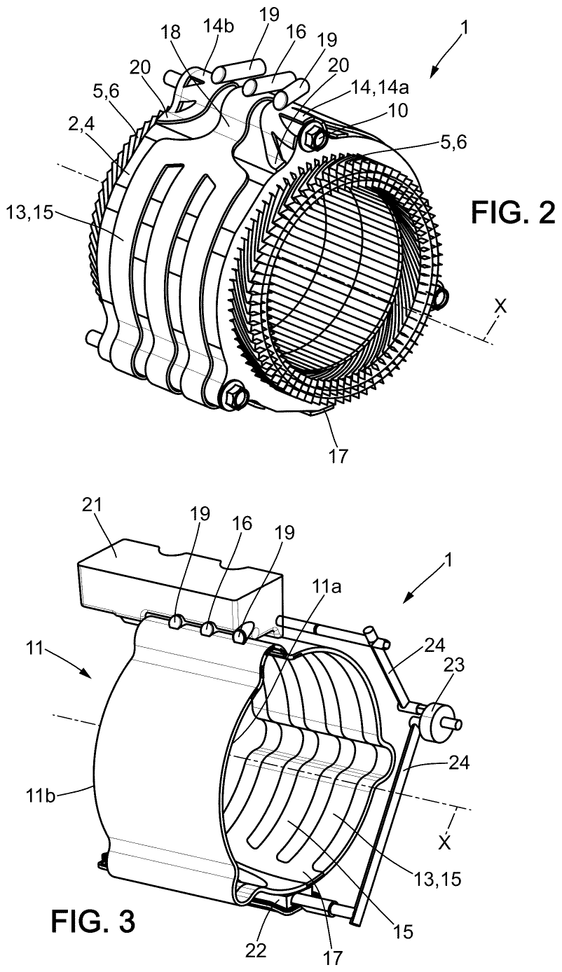

The body 4 may be formed of a stack of metal sheets, for example made of steel. Furthermore, the body 4 may comprise an annular part 7 and comprise, for example, three attachment lobes 8 (FIG. 1) extending radially outwards from the annular part 7. Each lobe 8 may extend axially and comprise a hole 9 for the passage of an attachment screw 10 (FIG. 2) capable of attaching the body 4 to a casing 3. Of course, the annular part may be without any such lobes 9. The casing 3 may be made of aluminum.

The winding 5 may be located radially inside the body 4.

The electric machine 1 comprises an annular cooling element 11, extending around the body 4.

The cooling element 11 may be in the form of a jacket or layer of elastomer material fitting closely against the general shape of the radially outer surface of the body 4. The cooling element 11 may thus comprise areas 12 that are complementary to the lobes 8 of the body 4.

The cooling element 11 may comprise a first cooling circuit 13 and a second cooling circuit 14.

The first cooling circuit 13 may comprise two parts that are generally symmetrical relative to a vertical plane. Each part may comprise several parallel channels 15, for example three channels 15, extending circumferentially between a coolant inlet 16 and a coolant outlet 17.

The coolant inlet 16 may be located in the upper portion of the cooling element 11 and may be shared by the three channels 15 of the first part and by the three channels 15 of the second part of the first cooling circuit 13. In particular, the coolant inlet 16 may be connected to the upper ends of the channels 15 of each part, by an upper connection area 18. Each part of the first cooling circuit may further comprise a coolant outlet 17 shared by the corresponding channels 15, exiting at an axial end 11a, 11b of the cooling element 11.

The coolant outlet 17 of the first part of the first circuit 13 may be at a first axial end 11a of the cooling element 11, and the coolant outlet 17 of the second part of the first circuit 13 may be at a second axial end 11b of said element 11, opposite the first end 11a.

The second cooling circuit 14 (FIG. 2), which is optional, may comprise a first part 14a and a second part 14b, each located in the upper portion of the cooling element 11.

Each part 14a, 14b of the second circuit 14 may comprise a shared coolant inlet 19 located in the upper portion, and several channels 20 extending from said inlet and leading to an axial end 11a, 11b of the cooling element 11. Each channel 20 of the second circuit 14 may comprise an outlet 20a that is distinct from those of the other channels 20 or may lead to a common outlet.

The outlets of the channels 20 of the first part 14a of the second circuit 14 may be at the first axial end 11a of the cooling element 11, and the outlets of the channels 20 of the second part 14b may be at the second axial end 11b of the cooling element 11.

The inlet 16 of the first circuit 13 and the two inlets 19 of the second circuit 14 may be supplied with coolant by a supply tank 21 (FIG. 3) located in the upper portion of the electric machine 1.

A collection tank 22 located in the lower portion may be capable of collecting coolant from the different circuits 13, 14. A heat exchanger may be combined with the collection tank, in order to keep the coolant temperature constant.

A pump 23 and pipes 24 may be used to convey the coolant from the collection tank 22 to the supply tank 21.

The coolant is, for example, oil.

Each channel 15, 20 of each circuit 13, 14 may have a rectangular cross-section and may comprise a radially inner surface and a radially outer surface in the shape of a portion of a cylinder, connected by radial sidewalls.

The radially inner surface may be formed by the radially outer surface 4a of the body 4 of the stator 2. In other words, the channels 15, 20 may be open radially inward where they are closed off by the body 4.

The cooling element 11 may comprise a matrix made of elastomer material capable of withstanding oils and/or high temperatures, for example on the order of 150° C., over long periods of time or continuously.

The matrix of the cooling element 11 is, for example, made of an elastomer selected from the following list: polyacrylics (ACM), ethylene acrylate copolymers (AEM), fluorocarbon polymers (FKM), fluorosilicones (FVMQ), hydrogenated nitrile (HNBR), or is composed of a blend of several elastomers from this list.

Furthermore, said elastomer may comprise fillers, for example such as carbon fillers (e.g. graphite, carbon nanotubes, carbon black, or graphene), metal fillers (e.g. Ag, Cu, Al, TiO2, AlN), and/or ceramic fillers (BN, Si).

The mass filler content is, for example, between 30 and 50%.

The elastomer material may be formulated so as to have a thermal conductivity λ>1 W·m−1·K−1.

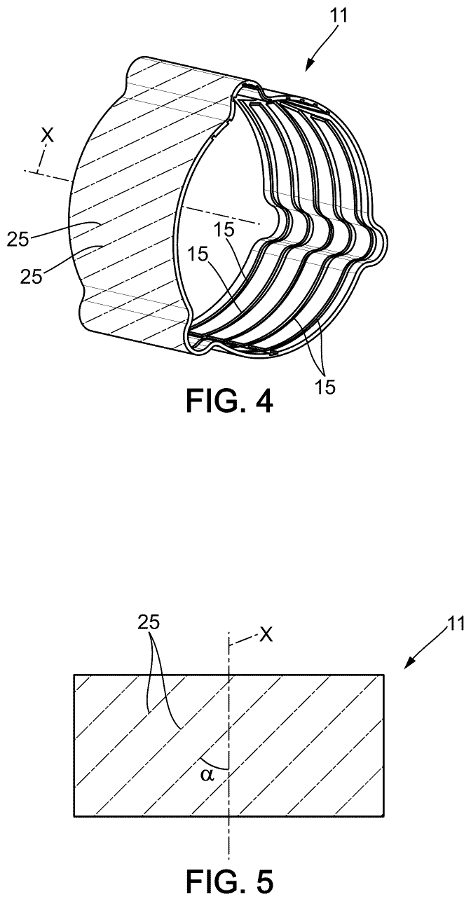

As illustrated in FIGS. 4 and 5, the cooling element 11 may also comprise elongate reinforcement elements 25, for example wires or threads, which are embedded in and integral with the elastomer matrix.

The wires or threads may be textile threads, at least in part, for example of polyamide or polyester. The wires or threads may also be metal wires, at least in part, for example of stainless steel or copper.

The reinforcement elements 25 may be regularly distributed around the circumference, at least a portion of the reinforcement elements 25 each extending along a spiral path around the jacket, the projection of the spiral path of each reinforcement element onto a plane parallel to the axis (FIG. 5) forming an angle a with said axis, the angle a being between 46 and 54°.

The coefficient of thermal expansion of the body 4 is lower than the coefficient of thermal expansion of the cooling element 11. In order to ensure the contact and seal between the body 4 and the cooling element 11, the latter is mounted on the body 4 in a prestressed or tight manner.

As indicated above, prestressed mounting, or tight mounting, means that the diameter of the cooling element 11 at rest, i.e. when not mounted around the body 4, is smaller than the diameter of the cooling element 11 in its mounted state around the body 4.

Furthermore, the annular casing 3 may have a coefficient of thermal expansion which is greater than or equal to the coefficient of thermal expansion of the body 4 and is less than the coefficient of thermal expansion of the cooling element 11.

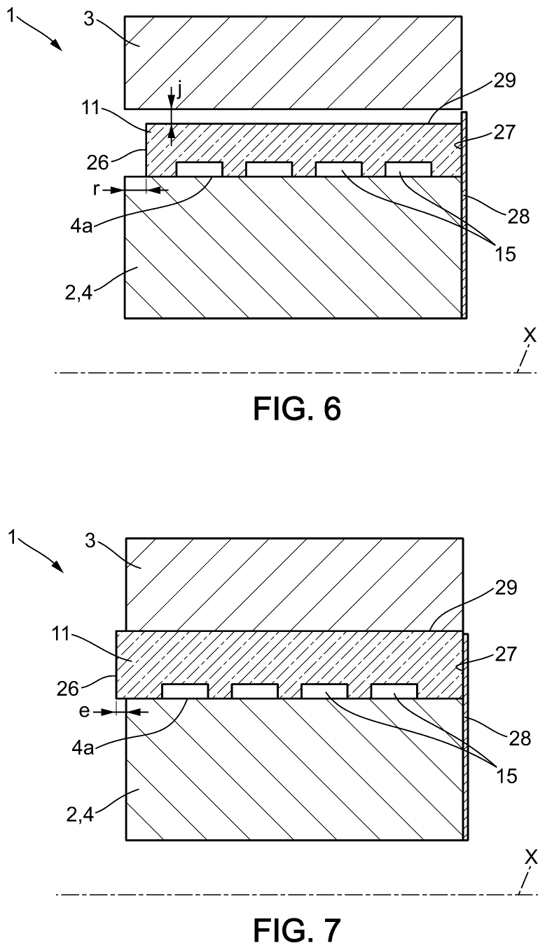

A radial annular clearance j (FIG. 6), for example of between 1 and 10 mm, may be formed between the cooling element 11 and the casing 3, at a first temperature, for example 20° C. This clearance j is capable of being filled in by the differential expansion between the cooling element 11 and the casing 3, starting at a second temperature, for example 90° C.

Of course, it is possible to adapt the electric machine 1 so that the second temperature is different from 90° C., for example is between 70 and 110° C.

Furthermore, the cooling element 11 has a first axial end 26 and a second axial end 27.

As illustrated in FIG. 6, the first axial end 26 may be axially recessed relative to the corresponding end of the stator 2, at the first temperature.

The term “recessed” means that said end 26 of the cooling element 11 does not protrude axially beyond the stator. Such a recess r is, for example, between 0 and 3 mm.

The second axial end 27 of the cooling element 1 may be capable of coming to bear against a flange 28 axially integral with the stator 2 and/or with the casing 3, so as to prevent the movement of said opposite axial end 27 beyond the corresponding end of the stator 2.

The radially outer surface 29 of the cooling element 11 may comprise at least one textured area comprising recessed portions and/or projecting portions, intended to bear against the casing 3.

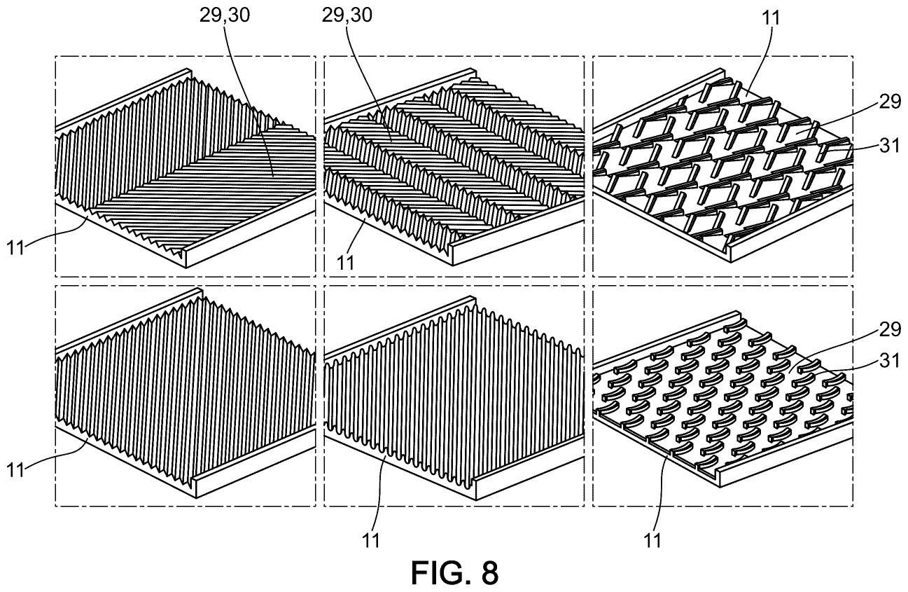

The projecting or recessed portions may comprise grooves 30, having a rectangular or triangular cross-section for example, oriented axially or at an angle relative to the X axis (see embodiments 2 and 4 in FIG. 8), or may have different grooves 30 with different orientations (see embodiments 1 and 3 in FIG. 8). Of course, any other type of projecting and/or recessed areas may be used. Thus, other types of rectilinear or curved bosses 31, illustrated in embodiments 5 and 6 of FIG. 8 for example, may be used.

During the operation of the electric machine 1, coolant is brought by the pump 23 to the supply tank 21 and is circulated through the channels 15, 20 of the first and second cooling circuits 13, 14 before emerging at the upper and lower portions of the axial ends 11a, 11b of the cooling element 11, through the outlets 17, 20a next to the end zones 6 of the windings 5, so as to cool them.

At startup, the coolant and more generally the various elements of the electric machine, in particular the stator 2, the cooling element 11, and the casing 3, are at a low temperature (or first temperature), for example 0° C. or 20° C. depending on the external environmental conditions for example.

At this temperature, the cooling element 11 is only in contact with the stator 2, as a clearance j exists between the radially outer surface 29 of the cooling element 11 and the casing 3. Furthermore, end 26 is recessed relative to the corresponding end of the stator 2.

During operation of the electric machine 1, the coolant sees its temperature increase, to reach an optimal operating temperature (or second temperature), for example 90° C. During this warming, the stator 2, the cooling element 11, and the casing 3 expand in a differentiated manner. During such warming, the expansion of the cooling element 11 in particular tends to fill in the clearance j, until the outer surface 29 of the cooling element 11 comes to bear against the casing 3. Furthermore, the reinforcement elements 25 allow limiting the axial expansion so that, even if the cooling element 11 may extend slightly beyond the stator 2 at the second temperature, such axial extension e remains limited (FIG. 7).

The cooling element 11 can then evacuate heat through the casing 3, which contributes to the temperature regulation of the coolant.

One will note that the recessed and/or protruding portions 30, 31 present on the outer surface 29 of the cooling element 11 are capable of gradually coming to bear against the casing 3 during the expansion of the cooling element 11, under the effect of the temperature increase. In other words, the contact area between the cooling element 11 and the casing 3 may gradually increase with the temperature.

Of course, this disclosure is in no way limited to the embodiment(s) described for illustrative, non-limiting purposes.

1.-9. (canceled)

10. An electric machine comprising
a stator and a rotor which is capable of pivoting about an axis,
an annular cooling element extending around at least a portion of the stator, said cooling element comprising at least one circulation channel capable of allowing the circulation of a coolant,
an annular casing extending around said axis and at least partly surrounding the cooling element,
characterized in that the stator has a first coefficient of thermal expansion, the cooling element having a second coefficient of thermal expansion which is greater than the first coefficient of thermal expansion, said cooling element being mounted around the stator in a prestressed manner,
the casing having a third coefficient of thermal expansion which is greater than or equal to the first coefficient of thermal expansion and is less than the second thermal coefficient, said casing surrounding the cooling element at least in part, a radial annular clearance being formed between the cooling element and the casing, at a first temperature, said clearance being capable of being filled in by the differential expansion between the cooling element and the casing, at a second temperature

11. The electric machine according to claim 10, wherein the matrix of the cooling element is made, at least in part, of elastomer material, for example rubber.

12. The electric machine according to claim 10, said cooling element comprising elongate reinforcement elements embedded in and integral with a matrix of synthetic material of the cooling element, the reinforcement elements being regularly distributed around the circumference, at least a portion of the reinforcement elements each extending along a spiral path around the jacket, the projection of the spiral path of each reinforcement element onto a plane parallel to the axis forming an angle with said axis, the angle being between 46 and 54°.

13. The electric machine according to claim 10, wherein the reinforcement elements are wires or threads.

14. The electric machine according to claim 10, wherein the radially outer surface of the cooling element comprises at least one textured area comprising recessed portions and/or protruding portions, intended to bear against the casing.

15. The electric machine according to claim 10, wherein the cooling element comprises at least one circulation channel for circulating a coolant.

16. The electric machine according to claim 15, wherein said channel leads, at least in part, to the radially inner surface of the cooling element, said channel being partly delimited by said cooling element and partly by the outer surface of the stator.

17. The electric machine according to claim 10, wherein at least one axial end of the cooling element is axially recessed relative to the corresponding end of the stator, at the first temperature.

18. A method of operating an electric machine according to claim 10, wherein, at the first temperature, a radial annular clearance is formed between the cooling element and the casing, and wherein, at the second temperature, said clearance is filled in by the differential expansion between the cooling element and the casing.
